(19) United States
(12) Patent Application Publication
(10) Pub. No.: US 2013/0244085 A1
(43) Pub. Date: Sep. 19, 2013

(54) BATTERY WITH NON-POROUS ALKALI METAL ION CONDUCTIVE HONEYCOMB STRUCTURE SEPARATOR

(71) Applicant: CERAMATEC, INC, Salt Lake City, UT (US)

(72) Inventors: Douglas M. Coors, Golden, CO (US); John Howard Gordon, Salt Lake City, UT (US)

(73) Assignee: Ceramatec, Inc, Salt Lake City, UT (US)

(21) Appl. No.: 13/855,528

(22) Filed: Apr. 2, 2013

Related U.S. Application Data
(63) Continuation-in-part of application No. 12/725,319, filed on Mar. 16, 2010.
(60) Provisional application No. 61/619,170, filed on Apr. 2, 2012.
(60) Provisional application No. 61/160,621, filed on Mar. 16, 2009.

(51) Int. Cl. H01M 2/18

(52) U.S. Cl. CPC H01M 2/18
USPC 429/160

(57) ABSTRACT

The present invention provides a rechargeable battery. The battery includes a honeycomb separator which defines therein a plurality of cells separated from adjacent cells by thin, non-porous cell walls of a substantially non-porous, alkali ion conductive ceramic membrane material. The battery includes a plurality of positive electrodes, each positive electrode being disposed in a respective positive electrode cell of the honeycomb separator. Each positive electrode cell contains a positive electrode electrochemical material that undergoes electrochemical reduction during battery discharge and electrochemical oxidation during battery charge. Negative electrodes are disposed in respective negative electrode cells of the honeycomb separator. Each negative electrode cell contains a negative electrode electrochemical material that undergoes electrochemical oxidation during battery discharge and electrochemical reduction during battery charge. The positive and negative electrodes are disposed in the cells of the honeycomb separator in a checkerboard pattern.

### CROSS-REFERENCE TO RELATED APPLICATIONS

This application claims the benefit of U.S. Provisional Patent Application No. 61/619,170, filed Apr. 2, 2012, entitled HIGH POWER, LOW TOTAL ENERGY STORAGE BATTERY WITH HONEYCOMB SEPARATOR. This application is also a continuation-in-part of U.S. patent application Ser. No. 12/725,319, filed Mar. 16, 2010, entitled SODIUM-SULFUR BATTERY WITH A SUBSTANTIALLY NON-POROUS MEMBRANE AND ENHANCED CATHODE UTILIZATION, which claims the benefit of U.S. Provisional Patent Application No. 61/160,621, filed Mar. 16, 2009, titled SODIUM-SULFUR BATTERY WITH A SUBSTANTIALLY NON-POROUS MEMBRANE AND ENHANCED CATHODE UTILIZATION, which is a continuation of U.S. patent application Ser. No. 12/205,759, filed Sep. 5, 2008, entitled LITHIUM-SULFUR BATTERY WITH A SUBSTANTIALLY NON-POROUS MEMBRANE AND ENHANCED CATHODE UTILIZATION, which claims the benefit of U.S. Provisional Patent Application No. 60/970,178, filed Sep. 5, 2007, titled HIGH RATE LITHIUM-SULFUR BATTERY WITH NON-POROUS CERAMIC SEPARATOR. The foregoing applications are each incorporated by reference.

### FIELD OF THE INVENTION

The present invention relates in general to batteries. More particularly, the present invention provides a battery having a non-porous alkali metal ion conductive honeycomb structure separator.

### BACKGROUND OF THE INVENTION

Batteries are known devices that are used to store and release electrical energy for a variety of uses. Our society has come to rely on batteries to power a myriad of devices, including computers, cell phones, portable music players, lighting devices, as well as many other electronic components. In order to produce electrical energy, batteries typically convert chemical energy directly into electrical energy. Generally, a single battery includes one or more galvanic cells, wherein each of the cells is made of two half-cells that are electrically isolated except through an external circuit. During discharge, electrochemical reduction occurs at the cell's positive electrode, while electrochemical oxidation occurs at the cell's negative electrode. While the positive electrode and the negative electrode in the cell do not physically touch each other, they are generally chemically connected by at least one (or more) ionically conductive and electrically insulative electrolyte(s), which can either be in a solid or a liquid state, or in combination. When an external circuit, or a load, is connected to a terminal that is connected to the negative electrode and to a terminal that is connected to the positive electrode, the battery drives electrons through the external circuit, while ions migrate through the electrolyte.

Batteries can be classified in a variety of manners. For example, batteries that are completely discharged only once are often referred to as primary batteries or primary cells. In contrast, batteries that can be discharged and recharged more than once are often referred to as secondary batteries or secondary cells. The ability of a cell or battery to be charged and discharged multiple times depends on the Faradaic efficiency of each charge and discharge cycle.

Batteries comprised of honeycomb structure separators are known in the art. For example, Berkey, et al. in U.S. Pat. No. 6,010,543 and in U.S. Pat. No. 5,916,706 disclose cells arranged in a honeycomb pattern where the separator walls are porous. Lyman in U.S. Pat. No. 5,567,544 discloses separator walls that wet with an electrolyte solution. Stempin, et al. in U.S. Pat. No. 5,554,464 discloses a honeycomb structure with thin, porous, ceramic walls. Kummer in U.S. Pat. No. 4,160,068 disclose a honeycomb separator being formed of a material having a porosity in the range which permits ions of electrolyte to flow there through.

The honeycomb structure separator offers many advantages. One advantage is providing a strong structure from thin membranes. Another advantage is providing an efficient structure with a large separator surface area which can be fabricated at low cost. Also the structure can provide a high ratio of separator area to electrode volume.

The prior art above recognizes the honeycomb separator structure, but in each case calls for a porous wall structure so that ions may conduct through the non-ceramic electrolyte contained in the pores.

There is an ongoing need for further advances in battery technology. It would be an improvement in the art to provide a battery having a non-porous alkali metal ion conductive honeycomb structure separator.

### BRIEF SUMMARY OF THE INVENTION

The present invention provides a rechargeable battery. The battery includes a honeycomb separator which defines therein a plurality of cells separated from adjacent cells by thin, non-porous cell walls of the honeycomb separator. The cells extend in parallel, longitudinal directions. The cell walls of the honeycomb separator comprise a substantially non-porous, alkali ion conductive ceramic membrane material. The substantially non-porous, alkali ion conductive ceramic membrane material may comprise a NASICON (Na Super Ion CONducting) type membrane material. The substantially non-porous, alkali ion conductive ceramic membrane material may comprise a LISICON (Li Super Ion CONducting) type membrane material. Other examples of solid alkali ion conductive electrolyte membranes include beta alumina, sodium-conductive glasses, etc. The honeycomb separator may be an extruded, ceramic material.

The battery includes a plurality of positive electrodes, each positive electrode being disposed in a respective positive electrode cell of the honeycomb separator. The positive electrodes may be electrically coupled in a positive electrode grid. Each positive electrode cell contains a positive electrode electrochemical material that undergoes electrochemical reduction during battery discharge and electrochemical oxidation during battery charge.

The battery further includes a plurality of negative electrodes, each negative electrode being disposed in a respective negative electrode cell of the honeycomb separator. The negative electrodes may be electrically coupled in a negative electrode grid. Each negative electrode cell contains a negative electrode electrochemical material that undergoes electrochemical oxidation during battery discharge and electrochemical reduction during battery charge.

The positive and negative electrodes are disposed in the cells of the honeycomb separator such that cells with positive electrodes are adjacent cells with negative electrodes in a checkerboard pattern.

In operation, the negative electrode electrochemical material may comprise an alkali metal. Non-limiting examples of alkali metals include sodium and lithium, and alloys thereof. In some embodiments, the negative electrode electrochemical material may comprise a molten alkali metal.

In operation, the negative electrode electrochemical material may comprise an alkali metal intercalation material. In some non-limiting embodiments, the intercalation material in the negative electrode comprises alkali metal intercalated with carbon (e.g., graphite, mesoporous carbon, boron-doped diamond, carbon, and/or graphene).

In operation, the positive electrode electrochemical material may comprise elemental sulfur and at least one solvent selected to at least partially dissolve the elemental sulfur and M₂Sₓ, wherein M is an alkali metal. In certain embodiments, the solvent includes an apolar solvent to dissolve the elemental sulfur and a polar solvent to dissolve the M₂Sₓ. In certain embodiments, the solvent consists of at least one polar solvent to at least partially dissolve the elemental sulfur and the M₂Sₓ.

In other embodiments, the positive electrode electrochemical material may comprise an alkali metal halide and corresponding halogen. Non-limiting examples include an alkali metal iodide, such as NaI and LiI, and iodine (I₂), and an alkali metal bromide, such as NaBr and Ibr, and bromine (Br₂).

These features and advantages of the present invention will become more fully apparent from the following description and appended claims, or may be learned by the practice of the invention as set forth hereinafter.

### BRIEF DESCRIPTION OF THE SEVERAL DRAWINGS

In order that the manner in which the above-recited and other features and advantages of the invention are obtained and will be readily understood, a more particular description of the invention briefly described above will be rendered by reference to specific embodiments thereof that are illustrated in the appended drawings. Understanding that the drawings are not made to scale, depict only some representative embodiments of the invention, and are not therefore to be considered to be limiting of its scope, the invention will be described and explained with additional specificity and detail through the use of the accompanying drawings in which:

FIG. 1 depicts an extruded honeycomb structure separator.

FIG. 2 depicts a cross-sectional representation of a honeycomb structure separator affixed to an electronically insulative planar base material.

FIG. 3 depicts a cross-sectional representation of a honeycomb structure separator as shown in FIG. 2 in which current collectors are attached to alternating negative electrodes and positive electrodes.

FIG. 4 depicts a top view of a honeycomb structure separator showing alternating negative electrodes and positive electrodes in adjacent cells forming a checkerboard pattern.

FIG. 5A depicts a top view of a honeycomb structure separator as shown in FIG. 4 with arrows indicating the flow of cations across the cell walls during battery discharge.

FIG. 5B depicts a top view of a honeycomb structure separator as shown in FIG. 4 with arrows indicating the flow of cations across the cell walls during battery charge.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. Additionally, while the following description refers to several embodiments and examples of the various components and aspects of the described invention, all of the described embodiments and examples are to be considered, in all respects, as illustrative only and not as being limiting in any manner.

Furthermore, the described features, structures, or characteristics of the invention may be combined in any suitable manner in one or more embodiments. In the following description, numerous specific details are provided, such as examples of suitable alkali metal negative electrodes, positive electrode materials, liquid positive electrolyte solutions, non-porous alkali metal ion conductive membrane, etc., to provide a thorough understanding of embodiments of the invention. One having ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As stated above, secondary cells can be discharged and recharged and this specification describes cell arrangements and methods for both states. Although the term “recharging” in its various forms implies a second charging, one of skill in the art will understand that discussions regarding recharging would be valid for, and applicable to, the first or initial charge, and vice versa. Thus, for the purposes of this specification, the terms “recharge,” “recharged” and “rechargeable” shall be interchangeable with the terms “charge,” “charged” and “chargeable” respectively.

The present invention provides a rechargeable battery utilizing a non-porous membrane wall in a honeycomb structure separator. Non-limiting examples of the non-porous membrane walls include an alkali ion conductive ceramic material such as NASICON-type material, LISICON-type material, and materials of the garnet structure which are ionically conductive. Berkey, Lyman, Stempin and Kummer noted above all teach away from non-porous membranes. The disclosed prior art systems require a porous honeycomb separator in the case of alkaline chemistries where over charging may lead to gas formation and passage of gas from one side of the membrane to the other to allow recombination is desirable. Otherwise, gases evolved from this reaction could result in an explosion or destruction of the cell. Furthermore, porous membranes are not suitable for many rechargeable battery systems, including systems where dendrite formation during recharge may penetrate through the membrane pores, shorting the cell or the undesirable migration of constituents through a porous separator will result in irreversible loss of cell capacity.

It would be a significant advancement in the art to provide non-porous honeycomb separator membranes so that certain rechargeable battery chemistries may be used. For example, if the chemistries of the two electrode types are incompatible such as in the case where one of the electrodes is a molten alkali metal, and the opposite electrode is a material that will react with the metal, such as an aqueous electrolyte, then the porous membrane could result in decomposition of one of the electrode materials.

The presently disclosed invention captures the advantages of using non-porous membrane separators and advantages of configuring the separators into a honeycomb structure: (1) The unit cost per cell can be much lower with the honeycomb compared to the individual cell because there is less labor and handling of pieces per membrane area; and (2) The overall honeycomb structure is strong and can handle stresses with thin membranes that individual tubes would not.

Fabricating rechargeable batteries with a honeycomb structure separator is an effective way to produce a rechargeable battery having a high energy density at sufficiently low cost.

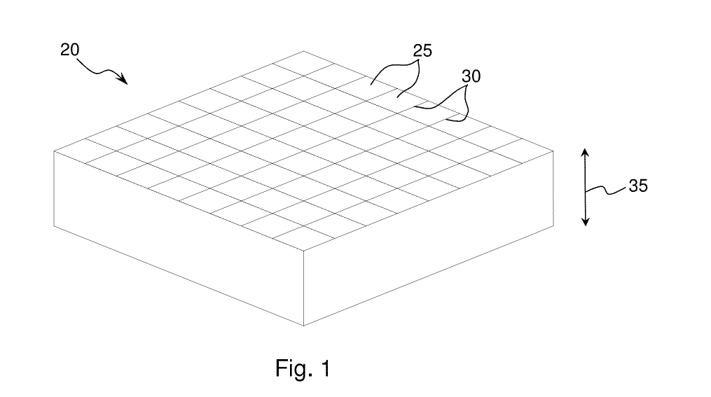

FIG. 1 is a non-limiting example of a honeycomb structure separator 20. The honeycomb separator 20 defines a plurality of cells 25 separated from adjacent cells by thin, non-porous cell walls 30 of the honeycomb separator 20. The cells extend in parallel, longitudinal directions 35. The cell walls 30 of the honeycomb separator 20 comprise a substantially non-porous, alkali ion conductive ceramic membrane material. The honeycomb separator may be fabricated using known extrusion processes.

The honeycomb separator 20 is formed of a material that is substantially non-porous yet alkali-metal ion conductive. The honeycomb material is resistant to attack by the materials forming the battery. Indeed, in some non-limiting implementations, the honeycomb material comprises a NaSICON-type membrane (e.g., a NaSELECT® membrane, produced by Ceramatec, Inc., in Salt Lake City, Utah). In another embodiment the honeycomb material is a LiSICON-type material, such as LiSICON-type materials produced by Ceramatec, Inc. The honeycomb separator may be selective to the transport of alkali ions while being substantially impermeable to water and other electrolyte materials used in the battery. The honeycomb separator structure may be fabricated using known ceramic extrusion processes.

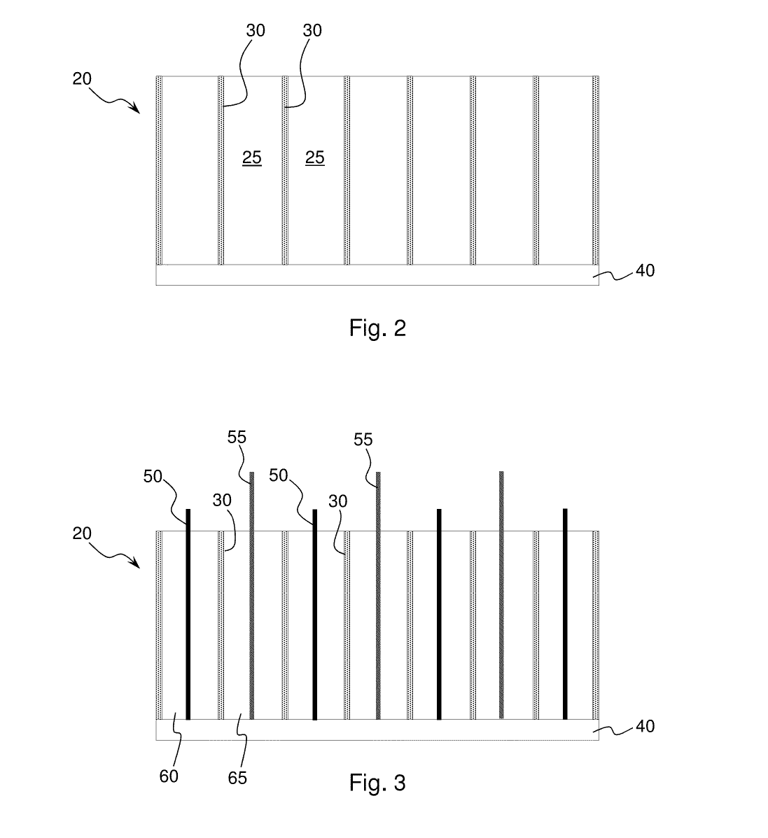

As shown in FIG. 2, the honeycomb structure separator 20 may be attached to an electronically insulative planar base material 40 to facilitate the construction of a multi-cell battery where the cell constituents and electrodes enter from the top. A suitable material for the base is non-porous alumina which may be attached to the extruded membrane material using glass or epoxy bonding.

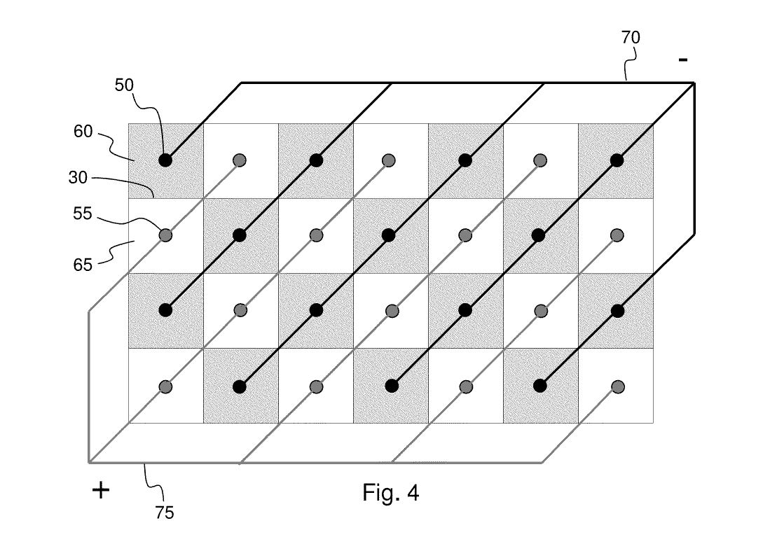

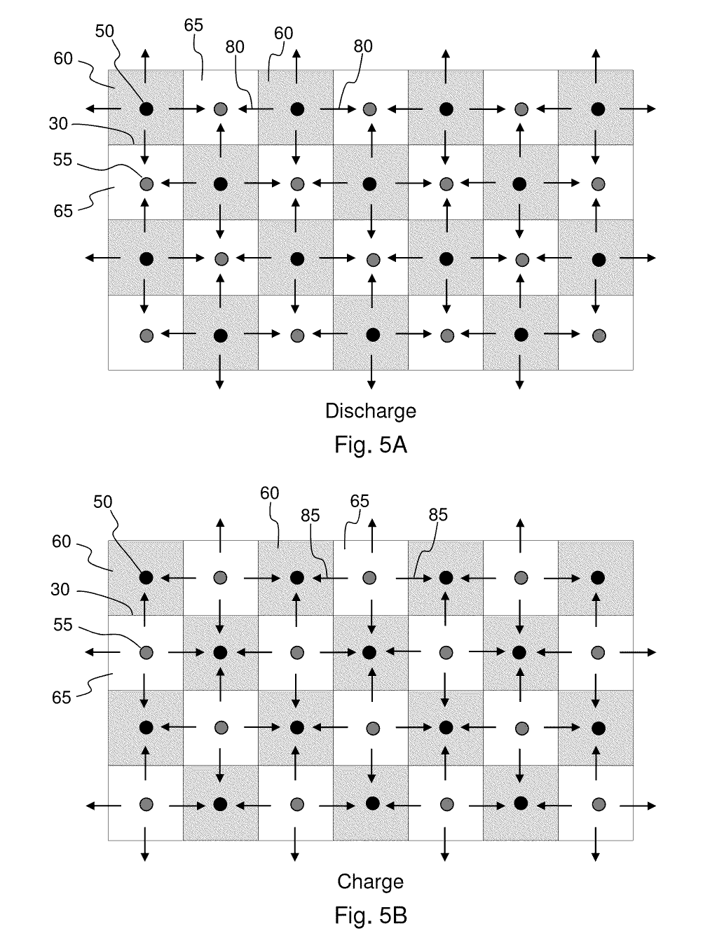

Current collectors can be attached effectively to alternating negative electrodes 50 and positive electrodes 55 as shown FIG. 3. Negative electrodes 50 are disposed in negative electrode cells 60. Positive electrodes 55 are disposed in positive electrode cells 65. Negative electrode cells 60 are preferably disposed adjacent negative electrode cells 65 in a checkerboard pattern, as shown in FIG. 4. Each of the cells with negative electrodes 50 may be electrically connected in a negative electrode grid 70. Each of the cells with positive electrodes 55 may be electrically connected in a positive electrode grid 75. FIG. 5A depicts a top view of a honeycomb structure separator as shown in FIG. 4 with arrows 80 indicating the flow of alkali metal cations, such as Na⁺ or Li⁺, across the cell walls during battery discharge. The cations flow from negative electrode cells 60 across cell walls 30 into positive electrode cells 65. FIG. 5B depicts a top view of a honeycomb structure separator as shown in FIG. 4 with arrows 85 indicating the flow of alkali metal cations across the cell walls during battery charge. The cations flow from positive electrode cells 65 across cell walls 30 into negative electrode cells 60.

The battery may include seals for sealing off the open ends of negative electrode cells 60 and the positive electrode cells 65 to make them fluid tight. The battery may also include vents (not shown) to permit the escape of generated gases therefrom. In one embodiment, the battery includes electrically insulative material to electrically insulate the negative electrodes from the positive electrodes.

The positive electrode cells contain a positive electrode electrochemical material that undergoes electrochemical reduction during battery discharge and electrochemical oxidation during battery charge. The negative electrode cells contain a negative electrode electrochemical material that undergoes electrochemical oxidation during battery discharge and electrochemical reduction during battery charge. A housing may hold the honeycomb separator, the negative electrodes, the positive electrodes, the seals, the gas vents, the electrically insulative material, the positive and negative electrochemical materials in an assembled condition.

With respect to the negative electrode 50, the negative electrode cells 60 can comprise any suitable alkali metal negative electrode 50 and/or associated current collector that allows the battery to function (e.g., be discharged and recharged) as intended. In some non-limiting embodiments, the negative electrode may comprise the negative electrode electrochemical material that undergoes electrochemical oxidation during battery discharge and electrochemical reduction during battery charge. Some non-limiting examples of suitable negative electrode materials include, but are not limited to, sodium or lithium that is substantially pure and a sodium or lithium alloy comprising any other suitable sodium or lithium-containing negative electrode material. In certain embodiments, however, the negative electrode comprises or consists of either an amount of sodium or an amount of lithium that is substantially pure.

In some embodiments, the negative electrode 50 comprises an alkali metal intercalation material that allows alkali metal in the negative electrode to be oxidized to form alkali metal ions as the battery is discharged, and that also allows alkali metal ions to be reduced and to intercalate with the intercalation material as the cell is recharged. In some embodiments, the intercalation material also comprises a material that causes little to no increase in the resistance of the alkali metal conductive membrane material. In other words, in some embodiments, the intercalation material readily transports alkali metal ions therethrough and has little to no adverse effect on the rate at which alkali metal ions pass from the negative electrode cell to the positive electrode cell (and vice versa). In some embodiments, the intercalation material in the negative electrode comprises alkali metal intercalated with carbon (e.g., graphite, mesoporous carbon, boron-doped diamond, carbon, and/or graphene).

For low temperature battery operation, the negative electrode cell 60 may contain a non-aqueous negative electrolyte solution (or secondary electrolyte). The non-aqueous negative electrolyte solution may comprise any suitable electrolyte that is capable of transporting alkali metal ions, that is chemically compatible with the materials of the negative electrode and the alkali metal ion conductive membrane, and that otherwise allows the cell to function as intended. Some non-limiting examples of suitable negative electrolyte solutions comprise organic electrolytes and ionic liquids. However, it is theorized that because certain ionic liquids have a higher ionic conductivity than the sodium ion conductive membrane and/or because some ionic liquids can act as a surfactant, such ionic liquids may impede dendrite formation on the negative electrode better than some organic electrolytes. Accordingly, in some non-limiting implementations, the negative electrolyte solution comprises an ionic liquid.

With respect to the positive electrode 55, the positive electrode cell 65 can comprise any suitable positive electrode 55 and/or associated current collector that allows the battery to be charged and discharged as intended. For instance, the positive electrode can comprise virtually any positive electrode material that has been successfully used in a sodium or lithium-based rechargeable battery system. In some embodiments, the positive electrode comprises one or more wires, strands of wires, pieces of felt, plates, tubes, meshes, pieces of foam, and/or one or more other suitable positive electrode configurations. Additionally, while the positive electrode can comprise any suitable material that may undergo oxidation-reduction reactions during charge and discharge, in some non-limiting embodiments it comprises elemental sulfur (typically S₈ molecules in solid form). The positive electrode cell may include at least one solvent selected to at least partially dissolve the elemental sulfur and M₂Sₓ (alkali metal monosulfide and/or polysulfide, where M is an alkali metal such as sodium or lithium).

In other embodiments, the positive electrode 55 may comprise a nickel foam, nickel hydroxide (Ni(OH)₂), nickel oxyhydroxide (NiOOH), sulfur composites, sulfur halides (including sulfuric chloride), carbon, copper, copper iodide, platinum, and/or another suitable material. Furthermore, these materials may coexist or exist in combinations. Indeed, in some embodiments, the positive electrode comprises copper, platinum, or copper iodide.

The positive electrode cells 65 may contain a liquid positive electrode solution compatible with the positive electrode material such as liquid electrolyte solutions. Where the positive electrode solution comprises an alkali metal compound, that compound can perform any suitable function, including, without limitation, helping the metal complex (discussed below) become soluble and protecting the alkali metal ion conductive electrolyte membrane from degradation by dissolution. While the alkali metal complex can comprise any suitable component, in some embodiments, it comprises an alkali ion and one or more halide ions and/or pseudo-halide ions.

In certain embodiments, one or more solvents may be selected to at least partially dissolve elemental sulfur and/or M₂Sₓ. The solvents will also ideally have a relatively high boiling point. Because M₂Sₓ is polar, in certain embodiments, a polar solvent may be selected to at least partially dissolve the M₂Sₓ. Similarly, because elemental sulfur is apolar, an apolar solvent may be selected to at least partially dissolve the elemental sulfur. Nevertheless, in general, the solvents may include any single solvent or mixture of solvents that are effective to at least partially dissolve elemental sulfur and/or M₂Sₓ.

Tetraglyme (TG), a polar solvent which is useful for dissolving M₂Sₓ, also significantly partially dissolves sulfur. Thus, tetraglyme by itself, or in combination with other polar solvents, may be used exclusively as the solvent or solvents in the positive electrode cell. This characteristic of tetraglyme (and possibly other polar solvents) is not believed to be disclosed in the prior art. In addition, tetraglyme is liquid over a wide temperature range, from −30° C. to 275° C. at 1 atmosphere pressure. The solubility characteristics of tetraglyme are especially beneficial when used with the substantially non-porous membrane walls of the honeycomb separator. Other solvents that may be used in the positive electrode cell may include tetrahydrafuran (THF) and/or dimethylanaline (DMA). DMA is apolar and has been found to be particularly effective at dissolving elemental sulfur, while also having a relatively high boiling point.

While specific embodiments and examples of the present invention have been illustrated and described, numerous modifications come to mind without significantly departing from the spirit of the invention, and the scope of protection is only limited by the scope of the accompanying claims.

1. A rechargeable battery comprising:
a honeycomb separator defining a plurality of cells separated from adjacent cells by thin, non-porous cell walls of the honeycomb separator, wherein the cells extend in parallel, longitudinal directions, wherein the cell walls of the honeycomb separator comprise a substantially non-porous, alkali ion conductive ceramic membrane material;
a plurality of positive electrodes, each positive electrode being disposed in a respective positive electrode cell of the honeycomb separator, the positive electrodes being electrically coupled in a positive electrode grid, each positive electrode cell contains a positive electrode electrochemical material that undergoes electrochemical reduction during battery discharge and electrochemical oxidation during battery charge;
a plurality of negative electrodes, each negative electrode being disposed in a respective negative electrode cell of the honeycomb separator, the negative electrodes being electrically coupled in a negative electrode grid, each negative electrode cell contains a negative electrode electrochemical material that undergoes electrochemical oxidation during battery discharge and electrochemical reduction during battery charge; and
wherein the positive and negative electrodes are disposed in the cells of the honeycomb separator such that the positive electrode cells are adjacent the negative electrode cells in a checkerboard pattern.

2. The rechargeable battery of claim 1, wherein the substantially non-porous, alkali ion conductive ceramic membrane is a NASICON-type membrane.

3. The rechargeable battery of claim 1, wherein the substantially non-porous, alkali ion conductive ceramic membrane is a LISICON-type membrane.

4. The rechargeable battery of claim 1, wherein the honeycomb separator is an extruded, ceramic material.

5. The rechargeable battery of claim 1, wherein the negative electrode electrochemical material comprises an alkali metal.

6. The rechargeable battery of claim 1, wherein the negative electrode electrochemical material comprises a molten alkali metal.

7. The rechargeable battery of claim 1, wherein the negative electrode electrochemical material comprises an alkali metal intercalation material.

8. The rechargeable battery of claim 1, wherein the alkali metal intercalation material comprises the alkali metal intercalated with carbon.

9. The rechargeable battery of claim 1, wherein the positive electrode electrochemical material comprises elemental sulfur and at least one solvent selected to at least partially dissolve the elemental sulfur and M₂Sₓ, wherein M is an alkali metal.

10. The rechargeable battery of claim 9, wherein the at least one solvent includes an apolar solvent to dissolve the elemental sulfur and a polar solvent to dissolve the M₂Sₓ.

11. The rechargeable battery of claim 9, wherein the at least one solvent consists of at least one polar solvent to at least partially dissolve the elemental sulfur and the M₂Sₓ.

12. The rechargeable battery of claim 1, wherein the positive electrode electrochemical material comprises an alkali metal halide and corresponding halogen.

13. The rechargeable battery of claim 1, wherein the positive electrode electrochemical material comprises an alkali metal iodide and iodine (I₂).

14. The rechargeable battery of claim 1, wherein the positive electrode electrochemical material comprises an alkali metal bromide and bromine (Br₂).

15. A rechargeable battery comprising:
an extruded ceramic honeycomb separator defining a plurality of cells separated from adjacent cells by thin, non-porous cell walls, wherein the cells extend in parallel, longitudinal directions, wherein the cell walls comprise a substantially non-porous, sodium ion conductive NASICON-type membrane material;
a plurality of positive electrodes, each positive electrode being disposed in a respective positive electrode cell of the honeycomb separator, the positive electrodes being electrically coupled in a positive electrode grid, each positive electrode cell contains a positive electrode electrochemical material that undergoes electrochemical reduction during battery discharge and electrochemical oxidation during battery charge;
a plurality of negative electrodes, each negative electrode being disposed in a respective negative electrode cell of the honeycomb separator, the negative electrodes being electrically coupled in a negative electrode grid, each negative electrode cell contains a negative electrode electrochemical material comprising sodium that undergoes electrochemical oxidation during battery discharge and electrochemical reduction during battery charge; and
wherein the positive and negative electrodes are disposed in the cells of the honeycomb separator such that the positive electrode cells are adjacent the negative electrode cells in a checkerboard pattern.

16. The rechargeable battery of claim 15, wherein the positive electrode electrochemical material comprises elemental sulfur and at least one solvent selected to at least partially dissolve the elemental sulfur and Na₂Sₓ.

17. The rechargeable battery of claim 15, wherein the positive electrode electrochemical material comprises a sodium halide and corresponding halogen.

18. A rechargeable battery comprising:
an extruded ceramic honeycomb separator defining a plurality of cells separated from adjacent cells by thin, non-porous cell walls, wherein the cells extend in parallel, longitudinal directions, wherein the cell walls comprise a substantially non-porous, lithium ion conductive LISICON-type membrane material;
a plurality of positive electrodes, each positive electrode being disposed in a respective positive electrode cell of the honeycomb separator, the positive electrodes being electrically coupled in a positive electrode grid, each positive electrode cell contains a positive electrode electrochemical material that undergoes electrochemical reduction during battery discharge and electrochemical oxidation during battery charge;
a plurality of negative electrodes, each negative electrode being disposed in a respective negative electrode cell of the honeycomb separator, the negative electrodes being electrically coupled in a negative electrode grid, each negative electrode cell contains a negative electrode electrochemical material comprising lithium that undergoes electrochemical oxidation during battery discharge and electrochemical reduction during battery charge; and
wherein the positive and negative electrodes are disposed in the cells of the honeycomb separator such that the positive electrode cells are adjacent the negative electrode cells in a checkerboard pattern.

19. The rechargeable battery of claim 18, wherein the positive electrode electrochemical material comprises elemental sulfur and at least one solvent selected to at least partially dissolve the elemental sulfur and Li₂Sₓ.

20. The rechargeable battery of claim 18, wherein the positive electrode electrochemical material comprises a lithium halide and corresponding halogen.
